(19) United States
(12) Patent Application Publication
(10) Pub. No.: US 2012/0324512 A1
(43) Pub. Date: Dec. 20, 2012

(54) ENHANCED ELECTRONIC PROGRAM GUIDE

(76) Inventors: Jens Cahnbley, Princeton Junction, NJ (US); Shemimon Manalikudy Anthru, Dayaton, NJ (US); David Anthony Campana, Princeton, NJ (US); David Brian Anderson, Florence, NJ (US); Ishan Mandrekar, Monmouth Junction, NJ (US)

(21) Appl. No.: 13/579,698

(22) PCT Filed: Dec. 10, 2010
(86) PCT No.: PCT/US10/03142

§ 371 Date: Aug. 17, 2012

Related U.S. Application Data
(60) Provisional application No. 61/306,204, filed on Feb. 19, 2010.

(51) Int. Cl. H04N 21/482

(52) U.S. Cl. 725/53

(57) ABSTRACT

A method for a system that provides an enhanced content guide includes a controller that receives electronic program guide data and parses the received electronic program guide data to identify a program listed in the electronic program guide and data corresponding to at least one program description attribute for the identified program. At least one external source of content information is searched using the Internet interface for information related to the identified program using the at least one program description attribute. A user interface generator generates an enhanced content guide user interface including the information related to the identified program for display on a display device in response to selection of the identified program in the electronic program guide.

### CROSS-REFERENCE TO RELATED APPLICATIONS

This application claims the benefit of U.S. Provisional Application Ser. No. 61/306,204 filed 19 Feb. 2010, and is hereby incorporated by reference in its entirety for all purposes.

### FIELD

The present arrangement provides a system and method that automatically searches and retrieves information from at least one source that is associated with content selected by a user.

### BACKGROUND

Conventionally, a subscriber to a cable or satellite provider accesses content using a set top box connected to a display device. When selecting content to be accessed at a given time, the user may employ an electronic program guide (EPG) that is displayable on screen in response to user generation of a control signal using a remote control. The EPG typically is a tabular formatted user interface that presents a listing of channels and information about programs on those channels for a given time period. The guide information displayed in the EPG user interface is sparse due to the limited screen real estate of the display device. Therefore, the guide is only able to display limited information about respective programs. For example, current EPG's merely list the program name, start and end time, a brief description, cast list, and possibly a rating (as in a television program guide TV-PG).

However, consumers now have access to vast libraries of content information that may provide additional insight into content available from a content provider. A drawback associated with accessing the vast amount of content available is that it can be a tedious task for a consumer/user to sort through and locate information describing the content and aggregate it in a meaningful manner. Typically, a user must actively and manually execute a web browser application on, for example, a personal computer, access a search engine and input a query for information on content that is currently being accessed. The results of these searches include links to a plurality locations including content information and the user must then navigate to the different locations to obtain the information. Therefore, there is a need to simplify the process of providing content information to consumers in a single display image to provide data representing an enhanced program guide to the user.

### SUMMARY

In one embodiment a method for providing an enhanced content guide is described. A controller receives electronic program guide data and parses the received electronic program guide data to identify a program listed in the electronic program guide and data corresponding to at least one program description attribute for the identified program. At least one external source of content information is searched using the at least one program description attribute via the internet interface for information related to the identified program. A user interface generator generates an enhanced content guide user interface including the information related to the identified program for display on a display device in response to selection of the identified program in the electronic program guide.

In a further embodiment, a system for providing enhanced content is described. A receiver receives electronic program guide data, the electronic program guide data. An internet interface provides communication to at least one external source of content information. An attribute processor parses the received electronic program guide data to identify a program listed in the electronic program guide and data corresponding to at least one program description attribute for the identified program. A content processor searches the at least one external source of content information for information related to the identified program using the at least one program description attribute via the internet interface. A user interface display processor generates an enhanced content guide user interface including the information related to the identified program for display on a display device in response to selection of the identified program in the electronic program guide.

The retrieval and usage of enhanced program information from various sources available through internet and other sources are leveraged to improve the program guide on a set top box.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is an block diagram of an exemplary components of the system in accordance with an aspect of an embodiment;

FIG. 2 is a flow diagram detailing the operation of an aspect of an embodiment

FIG. 3 is a block diagram of example components in accordance with an aspect of an embodiment; and

FIG. 4 is a flow diagram detailing the operation of an aspect of an embodiment.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

As used in this application, the term “component” is intended to refer to hardware, or a combination of hardware and software in execution. For example, a component can be, but is not limited to being, a process running on a processor, a processor, an object, an executable running on a processor, and/or a microchip and the like. By way of illustration, both an application running on a processor and the processor can be a component. One or more components can reside within a process and a component can be localized on one system and/or distributed between two or more systems. Functions of the various components shown in the figures can be provided through the use of dedicated hardware as well as hardware capable of executing software in association with appropriate software.

When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting instances and embodiments of the invention are intended to encompass both structural and functional equivalents. Additionally, it is intended that such equivalents include both currently known equivalents as well as equivalents developed in the future (i.e., any elements developed that perform the same function, regardless of structure).

It should be noted that any hyperlinks used herein are used for purposes of example only. These hyperlinks may or may not be active and may or may not contain data. Any data stored at the location corresponding to any hyperlink is not required for an understanding of the present invention.

Content providers provide access to different types of content to a plurality of users. For example, cable/satellite providers typically rent set top boxes to consumers which act as a portal or gateway for the delivery of different types of content. The equipment that selectively provides access to content advantageously accesses content guide data that can be decoded and displayed to a user on a display device. Content guide data includes a listing of at least one channel on which content may be accessed and information associated with the content on the at least one channel. An example is electronic program guide data that is delivered either directly inbound from the cable provider through the same channel as the broadcast data or through an added internet service that compiles and provides content guide data. The content guide data typically contains minimal information that describes the programs on particular channels at particular times due to bandwidth limitations and the large number of programs for which data is required.

However, much more information is available from various other sources and, if harnessed, could be used in producing a comprehensive content program guide that includes significantly more information than currently available in conventional program guides. The present system advantageously searches for and acquires related content information from a plurality of different external sources for use in producing a user interface display image that provides an enhanced content program guide to a user. The search and acquisition of related content information may be done in advance of the time at which the electronic program guide is to be displayed. The system advantageously identifies attributes associated with a respective program that provide particular types of information about the program and populates a database with the identified attributes. The identified attributes may be used as seed terms for a searching algorithm that automatically searches locations on a communication network for information that is related to the program. The results of these searches are automatically formatted into a user interface and presented to a user on at least one of a primary or secondary display device. Thus, the enhanced content guide may be displayed to the user as a replacement for the conventional electronic program guide data on which the search is based. For example, in response to a control signal from a user requesting program guide data, the system may display the enhanced content guide on at least one of the primary or secondary display device.

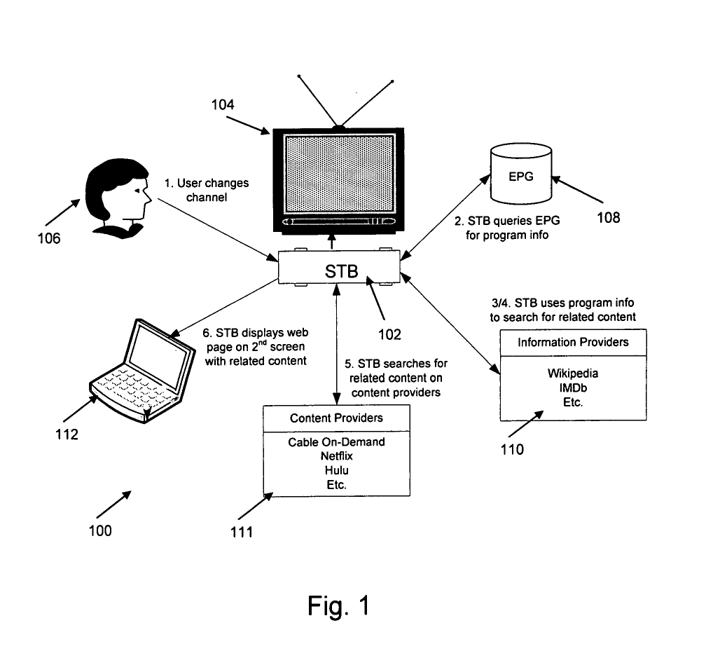

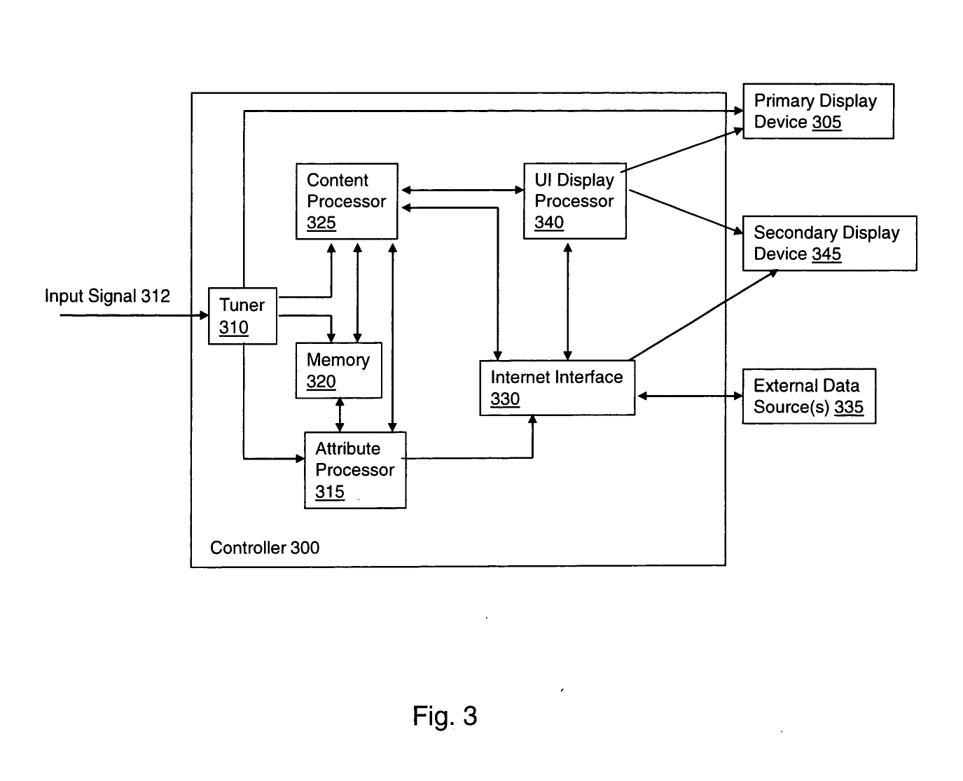

One exemplary embodiment of the system is shown in FIG. 1 which includes a set top box 102, for example a cable television set top box, including a tuner module that selectively tunes an input signal from a cable/satellite provider. Set top box 102 further includes an attribute processor (FIG. 3) that parses received program data, including program guide data, and populates a database executing on the set top box 102 with attributes that are associated with respective programs available to be tuned by the tuner module. In alternate embodiments, the database may be located outside of the set top box 102 such as a separate disc drive or a cloud database storage location. The structure of the database may have various tables that represent a particular time period of a day. In the respective tables, the attributes may be provided in the columns and the programs at that particular time period may be provided in the rows. An example of a set of attributes for each program at a particular time period that may be populated by the system include, but is not limited to:
Title;
Subtitle;
Description;
Synopsis (generally implies a longer description);
Cast (actors, presenters, directors, narrators, producers);
Images (screen shots, posters, box art, thumbnail);
Genre/category;
Ratings and Advisories (e.g., PG-13);
Reviews and Star Ratings;
Other episodes of the same program;
Online sources of information (the show/episode on Hulu, Fancast, Netflix . . . );
Related movies and shows;
Date of original airing;
Series data; and
Data describing topics/situations depicted in the program.

The system may obtain these, and other attributes, from a plurality of different sources including, but not limited to:
Electronic Program Guide provider (such as schedules direct);
Set Top Box (by querying the STB, the STB can have obtained the information from the content provider);
Cable/Satellite/FIOS feed;
Preferred Content Provider based search (for example, give special importance to asking Disney about Disney content, or Comcast about Comcast content, etc.);
Internet Searches: Google, Bing, Wikipedia and others expose search APIs. These can also be crawled independently;
DVR/PVR; and
Media Content on user's home network.

In the system embodiment 100 of FIG. 1, the set top box 102 is coupled to a primary display device 104, for example a high definition television monitor, which selectively displays content corresponding to the signal tuned by the tuner module in the set top box 102. While a set top box 102 is described as the access point enabling selection and viewing of content, it should be noted that any device including at least one tuner module enabling selection of content as primary content may be used to implement the present system. Alternatively, the system may be implemented by any device that allows any piece of content to be selected and provided to a user in any manner. A secondary display device 112 may be provided for display of the enhanced content guide generated by the system. The secondary display device 112 may be any computing device that has access to at least one of a local area network and wide area network and which can access and receive data representing the enhanced content from the set top box 102 for display thereon. Secondary display device 112 includes but is not limited to, a computer, a laptop, a netbook, a tablet computer, a cellular phone, a smart phone or a second monitor different from the primary display device 104.

The set top box 102 is controlled by a user 106 or other device (e.g. a VCR, a DVR, another tuner, etc) in a known manner, for example using a remote control (not shown), to cause the set top box 102 (or primary display device 104) to display a user interface including an electronic program guide on primary display device 104. The program guide data includes information that describes the plurality of programs that are available to be tuned at a give time. In creating the enhanced program guide for display on the second display device 112, program guide data and any other data identifying and/or describing program content are parsed by the system to retrieve attributes therefrom and populate the enhanced program guide database. The system may automatically parse the EPG and other data upon receipt and in advance of the present time frame in order to populate the enhanced content guide database in advance. For example, the system may parse the EPG data the night before to ensure set top box performance and display of data is not hindered when a user is actually viewing program content on the primary display device 104. In another embodiment, the attributes are derived by parsing the EPG data as a user selects a particular program within the EPG being displayed. In response to a control signal received from a user, the system selects a program from within the EPG for viewing data associated with the program. It is important to note that this selection does not necessarily mean that the program is being tuned by the tuner module, but rather that the data in the EPG is highlighted or otherwise designated as active to be shown to the user on the primary display device.

Thus, selection of a program within the EPG functions as a program identifier which identifies a respective program for which enhanced EPG data is requested and displayed. The system uses the program identifier to retrieve attribute data for the selected program for use in searching a plurality of external data sources of related content to be included as part of the enhanced EPG data. The set top box 102 further includes a user interface (UI) display processor (as shown in FIG. 3) for selectively displaying a user interface including the enhanced EPG data on the secondary display device 112. In one embodiment, the enhanced EPG data is displayed simultaneously on the secondary display device 112 with the user interface on the primary display that is showing the conventional EPG data. Moreover, in response to receipt of a control signal that causes the current program selection to change (i.e. scrolling through the guide), the system automatically updates the user interface on the secondary display device 112 with enhanced EPG data corresponding to the newly selected program. This advantageously provides the most information to a user at any given time about a particular selected program to aid in deciding whether or not to tune the program.

The following is an exemplary description of how an enhanced EPG is caused to be displayed on the secondary display device 112. The following includes a description of television shows and content associated with the television show. However, one skilled in the art would appreciate that the system is operable to tune any television show, either broadcast live or stored on a storage medium, and acquire a set of enhanced content associated therewith to be included as part of the enhanced EPG for display on the secondary display device 112.

In this exemplary embodiment, a user 106 may generate a control signal requesting a channel change. The set top box 102 queries the electronic service guide from the electronic service guide source 108 to derive description information associated with the tuned program. The description information is used by a related content search module executing on the set top box 102 to search information providers 110 for content that is related to the tuned program. In response to acquiring related information, the related information is used as an input for searching a set of content providers 111 to acquire content that is associated with the information about the tuned program. Once related content is acquired, the set top box 102 causes the data representing the related content to be displayed on a secondary display device 112, for example, as a web page enabling the user to selectively access the related content.

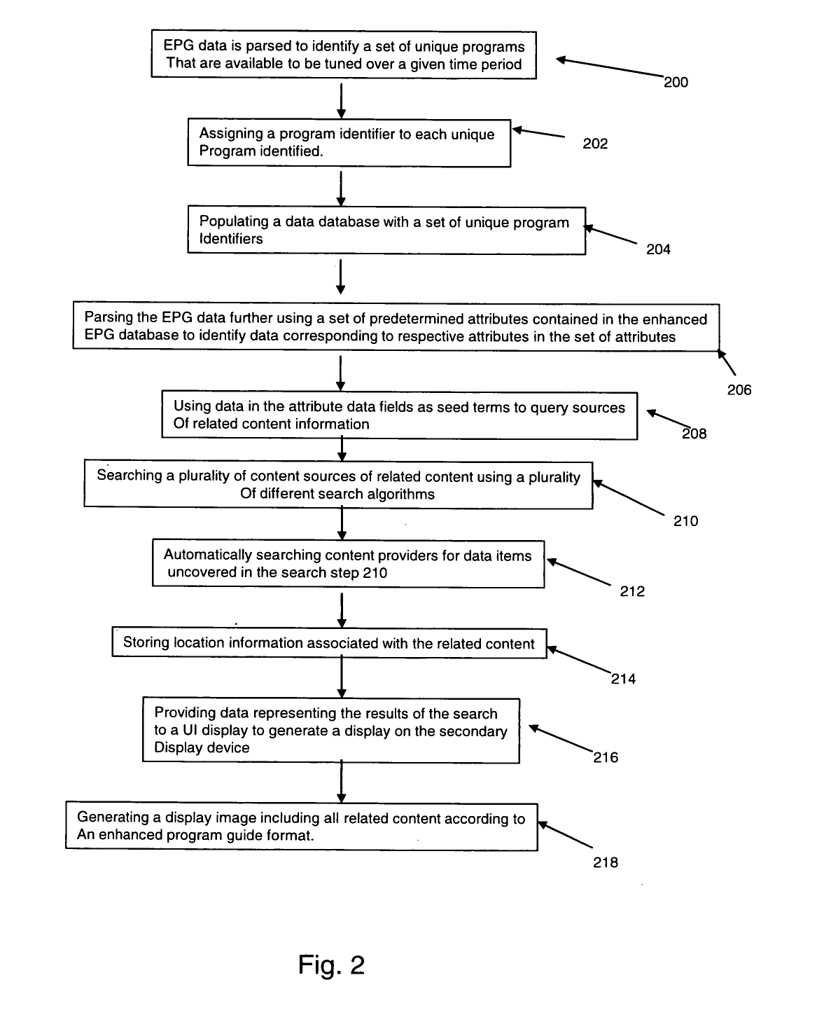

FIG. 2 is a flow diagram detailing an exemplary operation of the system described in FIG. 1 using the references numerals set forth therein. This embodiment describes the mechanism by which data is acquired and made part of the enhanced EPG data. In one embodiment, the processes/activities described herein are performed in advance of receiving a control signal identifying a program as the selected program thereby reducing the time needed to acquire related content information and generate a UI including the related content information. In another embodiment, the processes/activities described herein are performed in response to receipt of a control signal selecting content from within an EPG on the primary display.

In step 200, EPG data is parsed to identify a set of unique programs that are available to be tuned over a given time period. For each unique program identified, a program identifier is assigned thereto in step 202. In step 204, the enhanced EPG database is populated with a set of unique program identifiers enabling creation of records to which attribute data describing the program can be populated. The system further parses the EPG data 108 in step 206 using a set of predetermined attributes contained in the enhanced EPG database to identify data corresponding to respective attributes in the set of predetermined attributes. The attribute data is automatically used to populate the fields of the enhanced EPG database. The enhanced EPG database can be stored within the system hosting the related content search module (such as the set-top box) or externally, such as by a cable provider web service. Additionally, some sources of content information have very slow response times of about a second or more per query thereby causing queries associated with a few programs to be done efficiently. There are different ways to reduce the access time when the user needs this information. One way is by pre-querying the data ahead of time, such as a day ahead of the current program, and store the data for later use, for example in a database. This database can be filled with the enhanced information on a regular basis, such as once per day, and the program guide then only accesses this database when access of the external data source is not possible or limited in some aspect. This database can then be exposed as a web service or network API. The database can be located inside a home in a set top box and/or gateway, to allow multiple devices to access the data locally, and/or in the cloud to offer the information to a number of customers as a service.

In step 208, a related content search module executing on a content processor (FIG. 3), uses the data in the attribute data fields of the enhanced EPG database as seed terms to query sources for identifying related content information associated with respective programs available for tuning. A seed term is any description data in any attribute data field that describes a program available to be tuned by the set top box 102.

In step 210, the related content search module employs a plurality of different searching algorithms and processes in order to search sources of related content information 110 to be used in creating the enhanced EPG. For example, the manner in which data corresponding to the attributes are retrieved may require a proprietary query/response interface. Additionally, not each source offers data corresponding to each attribute in the set of attributes for each available program. To provide the user with the most complete set of data corresponding to the attributes in the set of attributes, the set top box 102, may prioritize information sources to ensure searching efficiency. For example, a first source (e.g. Wikipedia), may be thought to contain information corresponding to the most attributes in the set of attributes and a second source, (e.g. The Internet Movie Database—www.imdb.com) may be thought to contain the second most information. The system, in step 210, automatically searches and acquires information from the first source and, in the event the value in an attribute data field is empty, queries the second source for data corresponding to the attributes that are not filled. Thus, the system automatically initiates a search of a first list of sources and whenever an attribute is unavailable from one source on the list the system falls back to the next source.

In another embodiment, one attribute in the set of attributes may identify or describe a type of program. If the “type of program” attribute field has a value stored therein, the system in step 210, uses the value in the “type of program” field to select a source to be queried. This is particularly advantageous because not all content information sources allow unlimited access to their data during a certain timeframe. For example, NETFLIX™ only has information about movies and series, but not about TV shows, news or sports programs. The basic program guide typically offers enough information to know the program type before a query is made. This way, queries to NETFLIX™ can be limited to when appropriate.

Examples of information providers include but are not limited to Wikipedia, IMDB or any other source including information about audiovisual program data. In the present example, the related content search module automatically searches Wikipedia for the show's root article(s). The related content search module may utilize a proprietary search mechanism and algorithm or may use a third party search web service such as provided by Google or any other internet search provider. Upon locating the article corresponding to the television program Bones, this content is identified as enhanced related content and the resulting article is returned in a particular data format, (e.g. HTML/XHTML or Wikitext markup language) to be rendered for display to an end user.

The related content search module then parses the data representing the search results in step 212. Such analysis may occur using natural text parsing techniques or by exploiting standard Wikipedia formatting and by applying such analysis to links within the Wikipedia content. The results of this parsing by the related content search module are categorized and organized for use in generating a user interface display image representing an enhanced electronic program guide. The search results may include a plurality of user selectable image elements (e.g. links, icons, etc) to content that has been identified as being related to the program. This searching algorithm may be automatically repeated on each piece of related content to develop and create a more detailed and robust set of related content information that may be selectively stored locally or on a remote storage device accessible via a network that can be used in generating the enhanced electronic program guide.

In step 212, the related content search module automatically searches content providers 111 for items that may have been uncovered in the search step 210. The set of content providers may include at least one of (a) local user content (e.g., found on a home media server via UPnP on the local area network), (b) subscription services of the user (e.g., cable “On Demand” content, Netflix InstantWatch content, etc.), and (c) openly accessible Internet services (e.g., Hulu, Fancast, TV network sites, etc.). For example, the system may identify program data including an interview with the executive producer of the program and helps explains the program. The system may automatically acquire a link to this data for inclusion as part of the enhanced program guide on the secondary display. In another example, the search yield images of the actors in the program and the images may be incorporated in the enhanced program guide data, for example by direct download of image files or location data allowing the images to be downloaded upon presentation to the user.

The related content search module automatically locates a source that may provide the user with the related content information. Location information associated with results of the search in step 210 is stored in a memory within the set top box in step 214. Alternatively, the information may be stored in a memory in a cloud computing environment. Location information identifies the location of the related content. Location information may include any of (a) a universal resource locator (URL) pointing to an episode on Fancast, (b) a URL pointing to a set-top box provided web service that enables On Demand content to be played back with a click, (c) a URL pointing to the local network share path where the episode is stored and may be streamed, and (d) any other identifier enabling a user to access the related content. As used herein, the term ‘link’ can be used to describe such information, regardless of if the content is web-based. The link including location information may be presented to the user on the secondary display via the set top box 112 as discussed below.

The related content search module provides data representing the results of the search with links to the related content to a UI display processor (FIG. 3) executing on the set top box 102 in step 216. The UI display may be in the form of a web browser running on the secondary display device 112 that is pointed at a web server running on the set-top box 102. The UI display processor (FIG. 3) generates a display image including all related content to a program according to an enhanced program guide format that is specified by at least one of a user and the content provider in step 218.

In another embodiment, the enhanced content guide may be displayed in response to receipt of a control signal generated by a user and that includes a request for EPG data (e.g. depressing the “guide” button on a remote control). In this embodiment, the system automatically queries and retrieves from the database data representing enhanced content information associated with a range of channels during a particular time period. The retrieved enhanced content information may be provided to the UI display processor (FIG. 3) which generates a display image including the enhanced content information for display on at least one of a primary and secondary display device. The system may automatically repeat this operation in response to navigation signals received from a user. Thus, as the user scrolls through the enhanced program guide information on the at least one of the primary and secondary display device, the system automatically updates the enhanced content guide being displayed to reflect the range of available channels and programs.

FIG. 3 is a block diagram of an exemplary controller 300 that implements the system described above with respect to FIGS. 1 and 2. The controller 300 may be a hardware component embodied in a set top box 102 as shown in FIG. 1. The controller 300 includes a tuner 310 that selectively receives and tunes an input signal 312. The input signal may be a television broadcast signal formatted in a particular signal format such as those set forth by the Motion Pictures Experts Group (MPEG) or any other signal format used for encoding and transmitting audiovisual data and ancillary data associated with the audiovisual data. The tuner 310 decodes any ancillary data accompanying the tuned input signal 312 and stores the decoded data in a memory 320. The ancillary data may include Electronic Program Guide (EPG) data or any other data encoded and transmitted with the input signal 312. A primary display device 305 is coupled to the tuner 310 for displaying at least one of the tuned input signal and ancillary data including EPG data included in the input signal.

The memory 320 includes a data structure, such as a database, that includes a set of attributes used in describing program content. The attribute set may be predefined by the content provider (cable/satellite provider) and correspond to content characteristics that are transmitted along with the input signal that describe the various programs able to be tuned by tuner 310. The data structure in memory 320 enables each unique program listed in the ancillary data to be correlated with the plurality of attributes associated therewith which are derived from the ancillary data. In an alternative embodiment, the function of a database for the EPG function, may be located external to the controller 300. An external database (not shown), would interface to the content processor 325 via a suitable interface, such as a disc drive interface or a web interface for an external drive or cloud-based database respectively.

The controller 300 further includes an attribute processor 315 coupled to both the tuner 310 and the memory 320. The attribute processor 315 automatically parses the ancillary data to identify a set of unique programs able to be tuned and which are listed in the ancillary data. A unique program identifier is assigned to each unique program and is provided to the data structure in memory 320 thereby enabling collection of an individual set of related data for each respective unique program. The attribute processor 315 also automatically parses the received ancillary data to identify information that describes the program and corresponds to at least one attribute of the set of attributes. The data structure in memory 320 is automatically populated with data values representing the attribute information derived from the ancillary data. The attribute processor 315 uses the unique program identifier to link the attribute data to the program. The parsing and populating performed by the attribute processor 315 may occur in advance of the time frame in which the ancillary data will actually be displayed to a user. For example, if the ancillary data is electronic program guide data for a particular day, the parsing and populating of the data structure in memory 320 may occur at a predetermined time prior to the particular day. Alternatively, the parsing and populating may occur in response to receipt of a selection signal from a user.

In another embodiment, the system may automatically take into consideration user preferences and past user behavior data for use as input in order to search for related content. The system may automatically track user behavior including user navigation and content selection data that can be stored in memory 320. The system can further access the user preference and navigation data to identify other potential types of related content information and content sources that are displayed to the user on the secondary display device. By considering user preferences and behavior, the attribute processor may automatically update the set of attributes in the data structure stored in memory 320 thereby enabling additional attribute data to be collected and used in searching for related content information. For example, the user-specified attributes may enable the system to prioritize an order of sources of related content information to be searched.

A content processor 325 is coupled to the tuner 310, attribute processor 315, a user interface (UI) display processor 340 and the memory 320. The content processor 325 queries the data structure in memory 320 to acquire attribute data which may be used to search additional sources for related content information and for sources where related content is stored. The attribute data may be used as search terms in a searching algorithm to locate information about each respective program assigned a unique program identifier. The content processor 325 initiates a search across at least one of a local and wide area network for information about the program. The content information search algorithm executed by the content processor 325 engages an internet interface 330 which is coupled thereto to initiate a search of external data sources 335. Data representing the results of the search are retrieved by the content processor 325 and may be stored in memory 320. The search result data may be stored in a separate data structure than the attribute data but may be linked via the unique program identifiers so that the relevant data is quickly and easily retrieved when needed. Content processor 325 parses the retrieved related content information stored in memory 320 to compile a set of related content that may be used to generate an enhanced electronic program guide to be displayed to a user.

Content processor 325 may also automatically initiate a related content search algorithm which parses the search result data in the memory to search at least one external data source 335 for a source file of content corresponding to any data item listed in the search result data. As used herein, external data source 335 is a generic term used to denote any source of data for any purpose. For example, external data source 335 may be a source of content information (i.e. Wikipedia or IMDB.com) or a content provider (i.e. Netflix, Fancast.com). Upon performing the search for content, content processor 325 obtains the results including the location of the related content and content information. Content processor 325 automatically generates user-selectable links for any item for which location information has been obtained for the particular piece of content.

Content processor 325 provides data representing the related content that is associated with the unique program identifier for a particular program to a user interface (UI) display processor 340. UI display processor 340 automatically formats the related content according to a predetermined content guide format and causes the related content to be displayed on a secondary display device 345 which is separate and different from a primary display device 305 The UI display processor 340 is responsive to a control signal generated by a user. The control signal may include content guide navigation instructions that cause the UI display processor 340 to display the electronic guide data on a primary display device to allow a user to view available programs to be tuned. In response to this control signal, the content processor 325 automatically identifies the program selected by the user on the primary display and uses the unique program identifier to retrieve, from the memory 320, all related content information associated with the selected program. The content processor 325 provides the retrieved related content information to the UI display processor 340 which automatically formats the related content according to an enhanced EPG data format for display on the secondary device 345. Thus, the system advantageously automatically updates the user interface on the secondary display device 345 with the appropriate enhanced EPG data at substantially the same time at which the system is scrolling through the conventional EPG displayed on the primary display.

In one embodiment, the UI display processor may provide the formatted user interface to the internet interface 330 which functions as a webserver and allows a browser executing on the secondary device 345 to be pointed to a hosted user interface allowing user access thereto. Once presented on the secondary device 345, a user may browse and navigate the data items on the list in order to view and/or select related content that interests them.

In one embodiment, the system described in FIG. 3 automatically performs the content information search and content provider search for every program identified in the EPG data stored in memory 420 upon receipt of the EPG. The automatic search advantageously enables the system to populate a database with related content information at predetermined intervals when network/viewing activity is reduced. The system may then initiate and perform the above search algorithms on the data in the database when the user selects the primary content thereby reducing the amount of time required to provide the user with the set of enhanced related content.

In another embodiment, the system may be embodied in a server responsible for serving a set of users. In this embodiment, the server executes the search algorithms described above to populate the database and provides users access to the database to reduce the bandwidth and processing power needed to perform a full search of all of the possible content information and content provider sources. In response to selection of primary content, the set top box may automatically execute an application that initiates the content information and content provider search in the database of the server for related content thus reducing the amount of processing power, bandwidth and time required to provide the user with a set of enhanced content information.

While the above description of identifying and acquiring related content is described for a broadcast television program, one skilled in the art may apply the principles of the system to any type of content that is available to a user. In an alternate embodiment, the system may tune a music station enabling a user to listen to a radio program. In this embodiment, the system identifies the content by parsing radio program guide information and, in order to acquire related content, may search content information sources other than Wikipedia, Google, and Fancast as described above. The system would then search content provider sources that are specific to the type of primary content being accessed by the user, for example internet radio broadcast sites, the iTunes store, etc. The techniques also apply to scenarios beyond television such as music playback and the location of related music in the user's music library, on a subscription service such as Rhapsody, or on a purchase site such as Amazon MP3 and the like.

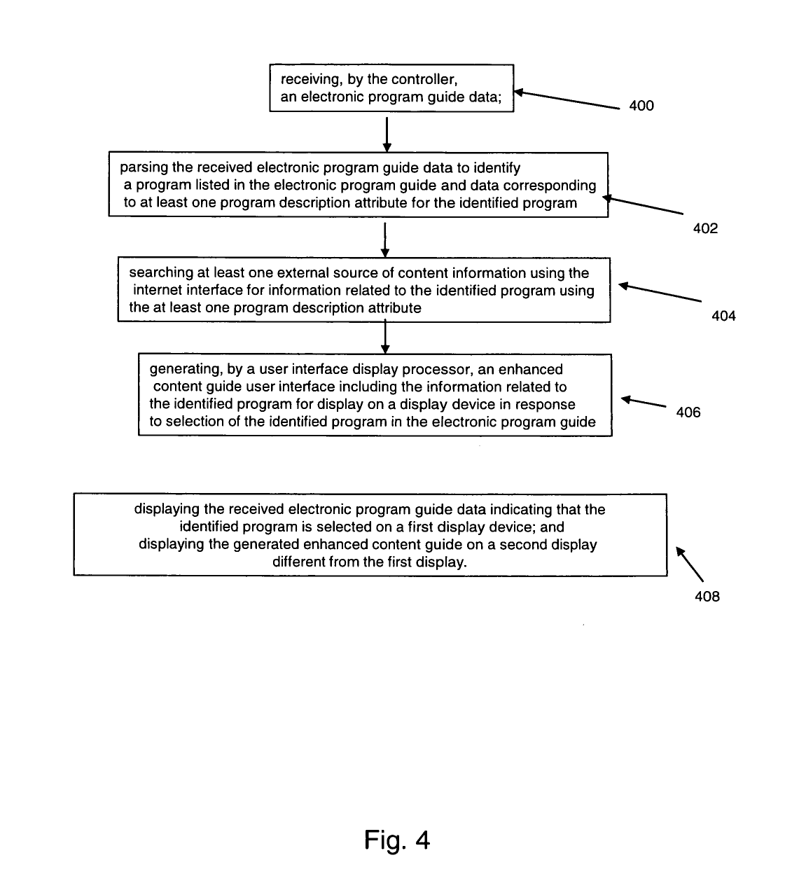

FIG. 4 is an exemplary algorithm implemented by the system described above with respect to FIGS. 1 and 3. The system advantageously provides an enhanced content guide using a controller with an internet interface. In step 400, a controller receives electronic program guide data. The received electronic program guide data is parsed to identify a program listed in the electronic program guide and data corresponding to at least one program description attribute for the identified program in step 402. At least one external source of content information is searched using the internet interface for information related to the identified program using the at least one program description attribute in step 404. In step 406, a user interface display processor generates an enhanced content guide user interface including the information related to the identified program for display on a display device in response to selection of the identified program in the electronic program guide. In one embodiment, steps 400-406 are repeated for each program listed within the electronic program guide.

In step 408, the received electronic program guide data indicating that the identified program is selected is displayed on a first display device and the generated enhanced content guide is displayed on a second display different from the first display. The displaying discussed in step 408 occurs substantially simultaneously thereby enabling a user scrolling though an electronic program guide and highlighting programs to see the enhanced content guide user interface that corresponds to the selected program in the conventional electronic program guide.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms (for example, a hardware apparatus, hardware and software apparatus, or a computer-readable media). An apparatus may be implemented in, for example, appropriate hardware, software, and firmware. The methods may be implemented in, for example, an apparatus such as, for example, a processor, which refers to any processing device, including, for example, a computer, a microprocessor, an integrated circuit, or a programmable logic device. Processing devices also include communication devices, such as, for example, computers, cell phones, portable/personal digital assistants (“PDAs”), and other devices that facilitate communication of information between end-users.

Additionally, the methods may be implemented by instructions being performed by a processor, and such instructions may be stored on a processor or computer-readable media such as, for example, an integrated circuit, a software carrier or other storage device such as, for example, a hard disk, a compact diskette, a random access memory (“RAM”), a read-only memory (“ROM”) or any other magnetic, optical, or solid state media. The instructions may form an application program tangibly embodied on a computer-readable medium such as any of the media listed above. As should be clear, a processor may include, as part of the processor unit, a computer-readable media having, for example, instructions for carrying out a process. The instructions, corresponding to the method of the present invention, when executed, can transform a general purpose computer into a specific machine that performs the methods of the present invention.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method of providing an enhanced content guide, the method performed by a controller with an internet interface, the method comprising:
a. receiving, by the controller, electronic program guide data;
b. parsing the received electronic program guide data to identify a program listed in the electronic program guide and data corresponding to at least one program description attribute for the identified program;
c. searching at least one external source of content information using the internet interface for information related to the identified program using the at least one program description attribute; and
d. generating, by a user interface generator, an enhanced content guide user interface including the information related to the identified program for display on a display device in response to selection of the identified program in the electronic program guide.

2. The method of claim 1 further comprising:
automatically repeating steps b-d for each program within the electronic program.

3. The method of claim 1, further comprising:
displaying the received electronic program guide data indicating that the identified program is selected on a first display device; and
displaying the generated enhanced content guide on a second display device different from the first display.

4. The method of claim 3, wherein the steps of displaying the received EPG and displayed the generated EPG occur substantially simultaneously.

5. The method of claim 1, further comprising the activities of:
scrolling, via the controller, through the list of programs listed in the electronic program guide data; and
automatically generating and displaying an enhanced content user interface for each subsequent program highlighted during the activity of scrolling.

6. The method of claim 1, further comprising
storing the information related to the identified program that corresponds to the at least one program description attribute in a in a memory, the identified program being linked with the related information in the memory.

7. The method of claim 6, further comprising the activity of
parsing the stored related information to identify content that is related to the identified program;
automatically searching a plurality of external data sources using the internet interface for content identified during said activity of parsing; and
retrieving related content for inclusion in the enhanced content guide user interface.

8. A system for providing enhanced content comprising:
a receiver that receives electronic program guide data;
an internet interface providing communication to at least one external source of content information;
an attribute processor that parses the received electronic program guide data to identify a program listed in the electronic program guide and data corresponding to at least one program description attribute for the identified program;
a content processor that searches the at least one external source of content information using the internet interface for information related to the identified program using the at least one program description attribute; and
a user interface generator that generates an enhanced content guide user interface including the information related to the identified program for display on a display device in response to selection of the identified program in the electronic program guide.

9. The system of claim 1, wherein
said user interface display generator
displays the received electronic program guide data indicating that the identified program is selected on a first display device; and
displays the generated enhanced content guide on a second display different from the first display.

10. The system of claim 9, wherein the electronic program guide data and the enhanced content guide are displayed substantially simultaneously.

11. The system of claim 8, wherein,
in response to scrolling through a list of programs listed in the electronic program guide data, said user interface generator automatically generates and displays an enhanced content user interface for each subsequent program highlighted while scrolling.

12. The system of claim 8, further comprising
a memory that stores the information related to the identified program that corresponds to the at least on program description attribute, the data structure linking the identified program with the related information.

13. The method of claim 12, wherein
said content processor
parses the stored related information to identify content that is related to the identified program;
automatically searches a plurality of external data sources using the internet interface for identified content; and
retrieves related content for inclusion in the enhanced content guide user interface.
